(19) United States
(12) Patent Application Publication
(10) Pub. No.: US 2008/0048627 A1
(43) Pub. Date: Feb. 28, 2008

(54) REGULATOR CIRCUIT AND INTEGRATED CIRCUIT DEVICE

(75) Inventor: Shinichiro KOBAYASHI, Hino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/775,909

(22) Filed: Jul. 11, 2007

(30) Foreign Application Priority Data
Jul. 14, 2006 (JP) 2006-193811

(51) Int. Cl. G05F 1/10; G05F 1/44

(52) U.S. Cl. 323/271; 323/282

(57) ABSTRACT

A regulator circuit for generating a regulation voltage obtained by stepping down a power supply voltage includes a plurality of voltage generation circuits that each generate a reference voltage; a differential amplifier circuit to whose first input terminal a reference voltage generated by one of the voltage generation circuits is inputted, to whose second input terminal the regulation voltage generated by the regulator circuit is inputted, and that amplifies a difference between the reference voltage and the regulation voltage; and an output circuit to which an output terminal of the differential amplifier circuit is coupled and that outputs the regulation voltage. The output circuit includes a first output transistor of a first conductivity type that is provided between an output terminal of the regulator circuit and a first power supply and to whose gate the output terminal of the differential amplifier circuit is coupled, and a second output transistor of a second conductivity type that is provided between a second power supply and the output terminal of the regulator circuit and to whose gate the output terminal of the differential amplifier circuit is coupled.

The entire disclosure of Japanese Patent Application No. 2006-193811, filed Jul. 14, 2006 is expressly incorporated by reference herein.

### 1. TECHNICAL FIELD

The present invention relates to a regulator circuit and an integrated circuit device.

### 2. RELATED ART

There have been known regulator circuits for stepping down an external power supply voltage to generate a regulation voltage. In these regulator circuits, for example, a voltage obtained by dividing the voltage of their output terminal using a resistive element, and a reference voltage are inputted into a first terminal and a second terminal (non-inverting input terminal/inverting input terminal) of an operational amplifier, and the gate of an output transistor is controlled by the output of the operational amplifier.

However, regulator circuits thus configured have a disadvantage in that the resistive element coupled to their output terminal consumes unnecessary power. On the other hand, using a resistive element having a high resistance so as to reduce power consumption causes a difficulty with inclusion of such a resistive element into an integrated circuit device. See JP-A-60-143012.

### SUMMARY

An advantage of an aspect of the invention is to provide a regulator circuit that efficiently supplies a current to a load circuit, and an integrated circuit including the same.

According to a first aspect of the invention, a regulator circuit for generating a regulation voltage obtained by stepping down a power supply voltage includes a plurality of voltage generation circuits that each generate a reference voltage; a differential amplifier circuit to whose first input terminal a reference voltage generated by one of the voltage generation circuits is inputted, to whose second input terminal the regulation voltage generated by the regulator circuit is inputted, and that amplifies a difference between the reference voltage and the regulation voltage; and an output circuit to which an output terminal of the differential amplifier circuit is coupled and that outputs the regulation voltage. The output circuit includes a first output transistor of a first conductivity type that is provided between an output terminal of the regulator circuit and a first power supply and to whose gate the output terminal of the differential amplifier circuit is coupled, and a second output transistor of a second conductivity type that is provided between a second power supply and the output terminal of the regulator circuit and to whose gate the output terminal of the differential amplifier circuit is coupled.

In the first aspect of the invention, the reference voltage generated by one of the voltage generation circuits, and the regulation voltage are inputted to the first and second input terminals, respectively, of the differential amplifier circuit in the regulator circuit. The output circuit in the regulator circuit includes the first and second output transistors. Coupled to each of the gates of the first and second output transistors is the output terminal of the differential amplifier circuit. These features cause the regulator circuit to operate so that the regulation voltage and the reference voltage become an identical voltage. Also, these features allow the first output transistor to serve as a variable resistive element, thereby efficiently supplying a current to a load circuit (load) coupled to the output terminal of the regulator circuit. Further, a desired regulation voltage can be obtained even though variations occur in the voltages generated by the voltage generation circuits.

In the regulator circuit according to the first aspect of the invention, the differential amplifier circuit may include a differential section having the first and second input terminals, a first output section to which a first output terminal of the differential section is coupled, and a second output section to which a second output terminal of the differential section is coupled.

For example, a current mirror can be used so that an identical bias current passes through the first and second output sections.

In the regulator circuit according to the first aspect of the invention, the differential section may include a first transistor of the second conductivity type for generating a bias current that is provided between the second power supply and a first node; a second transistor of the second conductivity type that is provided between the first node and a second node and whose gate is the first input terminal; a third transistor of the second conductivity type that is provided between the first node and a third node and whose gate is the second input terminal; a fourth transistor of the first conductivity type that is provided between the second node and the first power supply and a gate and a drain of which are each coupled to the second node; a fifth transistor of the first conductivity type that is provided between the third node and the first power supply, and a gate and a drain of which are each coupled to the third node; a sixth transistor of the second conductivity type that is provided between the second power supply and a fourth node, and whose gate is coupled to the fourth node; a seventh transistor of the first conductivity type that is provided between the fourth node and the first power supply and whose gate is coupled to the second node; an eighth transistor of the second conductivity type that is provided between the second power supply and a fifth node and whose gate is coupled to the fourth node; and a ninth transistor of the first conductivity type that is provided between the fifth node and the first power supply and whose gate is coupled to the third node.

These features make it possible to realize a regulator circuit that is few in polarities count and operates stably.

In the regulator circuit according to the first aspect of the invention, the differential section may include a tenth transistor of the first conductivity type that is provided between the second node and the first power supply and that is turned on or off depending on a control signal; and an eleventh transistor of the first conductivity type that is provided between the third node and the first power supply and that is turned on or off depending on a control signal.

These features make it possible to set the second and third nodes to the voltage of the first power supply when the tenth and eleventh transistors are turned on. This turns off the fourth and fifth transistors, thereby interrupting the current passing through the differential section and the like. Thus, power consumption can be reduced.

In the regulator circuit according to the first aspect of the invention, the output circuit may include a first output-state controlling transistor of the first conductivity type provided between the first output transistor and the first power supply, the first output-state controlling transistor being turned on or off depending on a control signal.

This feature makes it possible to interrupt the current passing through the output circuit when the first output-state controlling transistor is turned off, thereby reducing power consumption.

In the regulator circuit according to the first aspect of the invention, the output circuit includes a second output-state controlling transistor of the second conductivity type that is provided between the second power supply and an output terminal of the differential amplifier circuit and that is turned on or off depending on a control signal.

This feature makes it possible to set the output terminal of the differential amplifier circuit to the voltage of the second power supply when the second output-state controlling transistor is turned on. This turns off the second output transistor, thereby interrupting the current passing through the output circuit. Thus, power consumption can be reduced.

The regulator circuit according to the first aspect of the invention may further include a static-shielding resistive element provided between the second input terminal and an output terminal of the regulator circuit.

This feature can prevent the transistor or the like coupled to the second input terminal from being damaged by electrostatic discharge.

In the regulator circuit according to the first aspect of the invention, the voltage generation circuits may be controlled by a plurality of control signals. Any one of the voltage generation circuits may generate a reference voltage depending on the plurality of control signals. An output terminal of the other voltage generation circuit may be put into a high impedance state.

These features can prevent the output voltages of the voltage generation circuits from competing against one another.

The regulator circuit according to the first aspect of the invention may further include a plurality of coupling elements disposed between output terminals of the voltage generation circuits and the first input terminal of the differential amplifier circuit. Any one of the coupling elements may be turned on, and the other coupling elements may be turned off.

These features can prevent the output voltages of the voltage generation circuits from competing against one another.

The regulator circuit according to the first aspect of the invention may further include a plurality of switches disposed between output terminals of the voltage generation circuits and the first input terminal of the differential amplifier circuit. Any one of the switches may be controlled so as to be turned on depending on the control signals, and the other switches may be controlled so as to be turned off depending on the control signals.

These features can prevent the output voltages of the voltage generation circuits from competing against one another.

The regulator circuit according to the first aspect of the invention may further include a plurality of pieces of wiring disposed between output terminals of the voltage generation circuits and the first input terminal of the differential amplifier circuit. Conductivity of any one of the pieces of wiring may be enabled, and conductivity of the other pieces of wiring may be disabled.

These features can prevent the output voltages of the voltage generation circuits from competing against one another.

According to a second aspect of the invention, an integrated circuit device includes the regulator circuit according to claim 1 and an internal circuit that receives the regulation voltage from the regulator circuit as a power supply and that operates on the regulation voltage.

These features allow the internal circuit to operate using the regulation voltage from the regulator circuit as a power supply. This eliminates the need to provide a power supply for the internal circuit from the outside of the integrated circuit device, thereby allowing the system configuration to be simplified.

The regulator circuit according to the second aspect of the invention may further include a first pad to which an output terminal of the regulator circuit is coupled.

This feature makes it possible to couple a capacitor to the output terminal of the regulator circuit, to supply a regulation voltage from the outside of the integrated circuit device to the internal circuit, and to do other things.

In the regulator circuit according to the second aspect of the invention, a capacitor for stabilizing the regulation voltage generated by the regulator circuit may be coupled to the first pad.

This feature makes it possible to reduce a variation in the regulation voltage even in a case that the regulator circuit responds at a low speed, or other cases.

### BRIEF DESCRIPTION OF THE DRAWINGS

The invention will be described with reference to the accompanying drawings, wherein like numbers reference like elements.

FIG. 1 shows a configuration example of a regulator circuit according to an embodiment of the invention.

FIG. 2 shows a configuration example of a regulator circuit according to a comparative example.

FIG. 3 shows a detailed configuration example of the regulator circuit.

FIG. 4 shows a simulation result of a signal at each node of the regulator circuit.

FIG. 5 shows a first modification of this embodiment.

FIG. 6 shows a simulation result of the transient characteristic of the regulation voltage when capacitors with various capacities are used.

FIG. 7 shows a second modification of this embodiment.

FIG. 8 is a drawing showing a technique for controlling the state of an output terminal.

FIGS. 9A and 9B are both a drawing showing a technique for controlling the state of the output terminal.

FIG. 10 shows a third modification of this embodiment.

FIG. 11 shows a fourth modification of this embodiment.

FIG. 12A is a drawing showing the configuration of a voltage generation circuit and FIG. 12B is a drawing showing the operation of the voltage generation circuit.

FIG. 13 is a drawing showing the operation point of the voltage generation circuit.

FIG. 14 shows a fifth modification of this embodiment.

FIG. 15 shows a sixth modification of this embodiment.

FIG. 16 shows a configuration example of the voltage generation circuit.

FIG. 17 shows a seventh modification of this embodiment.

FIG. 18 shows a configuration example of the voltage generation circuit.

FIG. 19 shows a layout example of an integrated generation circuit.

FIG. 20 shows a layout example of an I/O cell.

FIG. 21 shows a layout example of the I/O cell.

### DESCRIPTION OF EXEMPLARY EMBODIMENTS

An embodiment of the invention will now be described in detail. The embodiment described below does not unreasonably limit the spirit and scope of the invention set forth in the appended claims. All configurations described in this embodiment are not essential as problem-solving means of the invention.

1. Configuration

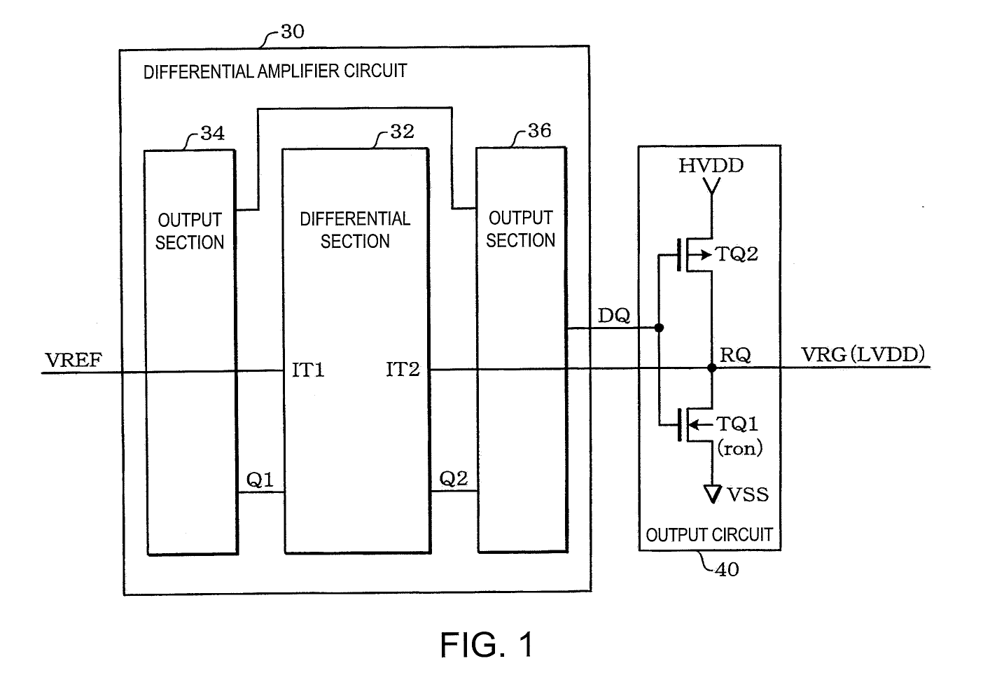

FIG. 1 shows a configuration example of a regulator circuit according to this embodiment. This regulator circuit is a circuit for stepping down the voltage of a power supply HVDD (“second power supply” as a broader term) to generate a regulation voltage VRG (final power supply voltage LVDD). It includes a differential amplifier circuit 30 and an output circuit 40. Inputted into its first input terminal IT1 (either one of the non-inverting input terminal and the inverting input terminal) is a reference voltage VREF. Inputted into its second input terminal IT2 (the other one of the non-inverting input terminal and the inverting input terminal) is a regulation voltage VRG outputted by the regulator circuit. The differential amplifier circuit 30 amplifies the difference between the reference voltage VREF and regulation voltage VRG and outputs the amplified voltage to an output terminal DQ. The output terminal DQ of the differential amplifier circuit 30 is coupled to the output circuit 40 (driver circuit). The output circuit 40 generates the regulation voltage VRG based on the amplified voltage from the differential amplifier circuit 30 and outputs the regulation voltage VRG.

The output circuit 40 includes an n-type (“first conductivity type” as a broader term) first output transistor TQ1 (drive transistor) that is provided between the output terminal RQ of the regulator circuit and a power supply VSS (“first power supply” as a broader term) and to whose gate the output terminal DQ of the differential amplifier circuit 30 is coupled. The output circuit 40 also includes a p-type (“second conductivity type” as a broader term) second output transistor TQ2 (drive transistor) that is provided between the power supply HVDD (second power supply) and the output terminal RQ and to whose gate the output terminal DQ of the differential amplifier circuit 30 is coupled.

More specifically, the differential amplifier circuit 30 includes a differential section 32 having a first input terminal IT1 and a second input terminal IT2, a first output section 34 to which a first output terminal Q1 of the differential section 32 is coupled and a second output section 36 to which a second output terminal Q2 of the differential section 32 is coupled. The output sections 34 and 36 are controlled by a current mirror or the like so that identical bias current passes through these output sections. The output terminal DQ of the output section 36 is coupled to the output circuit 40. The configuration of the differential amplifier circuit 30 is not limited to that shown in FIG. 1 and various modifications can be made thereto.

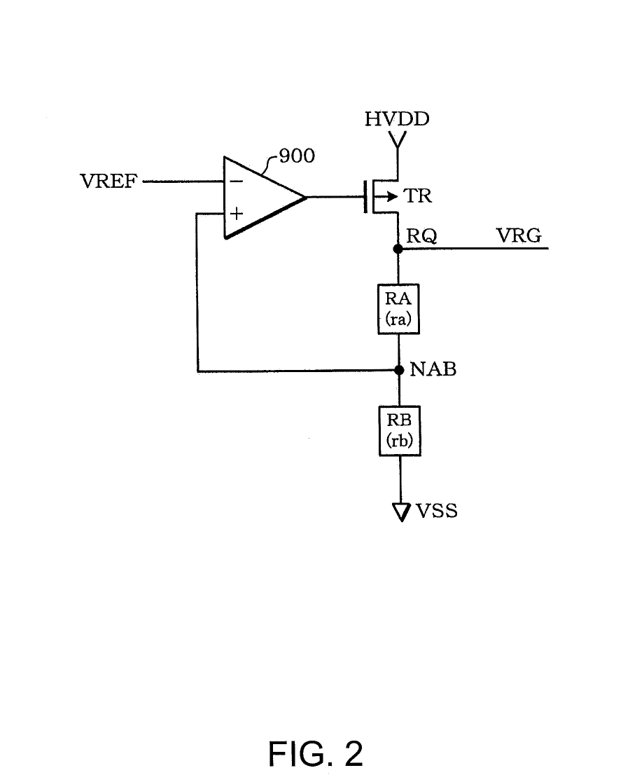

FIG. 2 shows a regulator circuit according to a comparative example. In this regulator circuit, the regulation voltage VRG of the output terminal RQ is divided by resistive elements RA and RB. A voltage obtained by dividing VRG by the resistive elements RA and RB is inputted into the non-inverting input terminal of an operational amplifier 900 (differential amplifier circuit). The reference voltage VREF is inputted into the inverting input terminal of the operational amplifier 900. The gate of the output transistor TR is controlled by the operational amplifier 900.

In the comparative example shown in FIG. 2, the reference voltage VREF is determined in consideration of the characteristics of a differential pair transistor (a transistor to whose gate the non-inverting terminal and the inverting input terminal are coupled) of the operational amplifier 900 and a response time obtained from these characteristics. A voltage divide ratio is determined using resistances ra and rb based on the reference voltage VREF.

However, in this comparative example, a certain amount of current always passes through the resistive elements RA and RB regardless of the magnitude of current consumption (operating current) of a load circuit coupled to an output terminal RQ of the regulator circuit. This results in consumption of unnecessary power.

In this case, if the regulator circuit is one of a group of products in which the substrate configuration itself can freely be designed, such as a full-custom product, using elements each having a high resistance per unit area as the resistive elements RA and RB allows the current passing through RA and RB to be reduced.

However, in a semi-custom product, particularly, a gate array or the like, only limited elements can be provided on the substrate and resistive elements that can be used as RA and RB have limited resistances. This results in very high current consumption in RA and RB.

On the other hand, in this embodiment shown in FIG. 1, the regulation voltage VRG per se rather than a voltage obtained by dividing the regulation voltage VRG (final power supply voltage LVDD) returns to the differential amplifier circuit 30. In other words, the regulation voltage VRG is inputted into the second input terminal IT2 of the differential amplifier circuit 30. This causes the differential amplifier circuit 30 to operate so that the reference voltage VREF and the regulation voltage VRG becomes an identical voltage.

In this case, if current consumption of the load circuit coupled to the output terminal RQ of the regulator circuit becomes extremely low, the regulation voltage VRG is raise up to the power supply voltage HVDD. To prevent this happening, this embodiment includes an n-type transistor TQ1 serving as a variable resistive element rather than the resistive elements RA and RB, as shown in FIG. 2. In this way, the regulation voltage VRG is prevented from becoming larger than a predetermined voltage. The output terminal DQ of the differential amplifier circuit 30 is commonly coupled to the gates of the n-type output transistor TQ1 and p-type output transistor TQ2.

Therefore, if current consumption of the load circuit becomes low and the regulation voltage VRG is increased, the voltage of the output terminal DQ of the differential amplifier circuit 30 is increased in order to prevent the voltage of the regulation voltage VRG from being increased. This increases the ON-resistance of the p-type output transistor TQ2 as well as reduces the ON-resistance of the n-type output transistor TQ1 (the current that passes through TQ1 is increased).

On the other hand, if current consumption of the load circuit becomes high and the regulation voltage VRG is reduced, the voltage of the output terminal DQ of the differential amplifier circuit 30 is reduced in order to prevent the voltage of the regulation voltage VRG from being reduced. This reduces the ON-resistance of the p-type output transistor TQ2 as well as increases the ON-resistance of the n-type output transistor TQ1 (the current that passes through TQ1 is reduced).

For example, in the comparative example shown in FIG. 2, a certain amount of current always passes through the resistive elements RA and RB, so unnecessary current is consumed. On the other hand, this embodiment includes the n-type output transistor TQ1 coupled to the n-type transistor TQ1 to whose gate the output terminal DQ of the differential amplifier circuit 30 is coupled and which serves as a variable resistive element. Therefore, if current consumption of the load circuit is high, the ON resistance of the n-type output transistor TQ1 is increased. This reduces the current passing through TQ1, allowing a large amount of current to be supplied to the load circuit. As a result, a current can efficiently be supplied to the load circuit.

In the comparative example shown in FIG. 2, VRG={(ra+rb)/rb}×VREF, so variations in the resistances ra and rb of the resistive elements RA and RB and the temperature characteristic of these resistances negatively affect generation of the regulation voltage VRG.

On the other hand, in this embodiment, the regulation voltage VRG itself returns to the input terminal IT2 of the differential amplifier circuit 30. In other words, direct comparison is made between the reference voltage VREF and the regulation voltage VRG in the differential amplifier circuit 30. This is advantageous in that variations in the resistances and the temperature characteristic thereof will not negatively affect the regulation voltage VRG.

2. Detailed Configuration

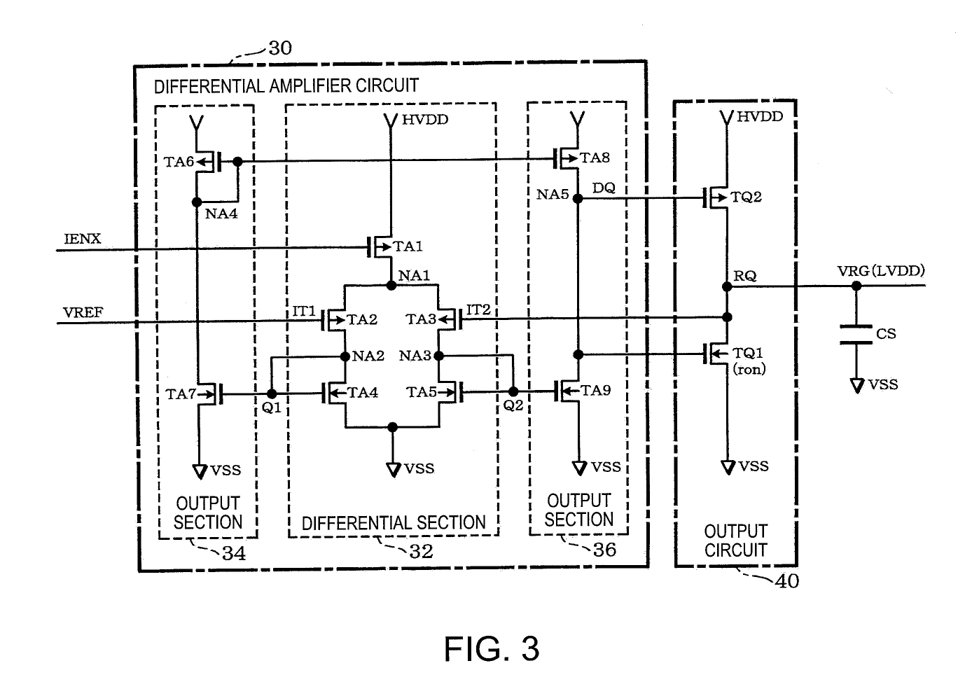

FIG. 3 shows a detailed configuration example of the regulator circuit according to this embodiment. The configuration of the regulator circuit is not limited to that shown in FIG. 3 and various modifications, such as a change in the coupling relations among elements or addition of other circuit elements, can be made.

In FIG. 3, the differential section 32 includes a p-type transistor TA1 for generating a bias current provided between the power supply HVDD and a node NA1. It also includes a p-type transistor TA2 that is provided between the node NA1 and a node NA2 and whose gate is the input terminal IT1, and a p-type transistor TA3 that is provided between the node NA1 and a node NA3 and whose gate is the input terminal IT2. It also includes an n-type transistor TA2 that is provided between the node NA2 and the power supply VSS (GND) and whose gate and drain are coupled to the node NA2, and an n-type transistor TA5 that is provided between the node NA3 and the power supply VSS and whose gate and drain are coupled to the node NA3.

The output section 34 includes a p-type transistor TA6 that is provided between the power supply HVDD and the node 4 and whose gate is coupled to the node NA4, and an n-type transistor TA7 that is provided between the node NA4 and the power supply VSS and whose gate is coupled to the node NA2. The output section 36 includes a p-type transistor TA8 that is provided between the power supply HVDD and the node 5 and whose gate is coupled to the node NA4, and an n-type transistor TA9 that is provided between the node NA5 and the power supply VSS and whose gate is coupled to the node NA3.

According to the regulator circuit having the configuration shown in FIG. 3, the polarities count can be reduced, for example, to one. This can prevent the circuit from oscillating due to external noise or the like, thereby allowing the circuit to operate stably.

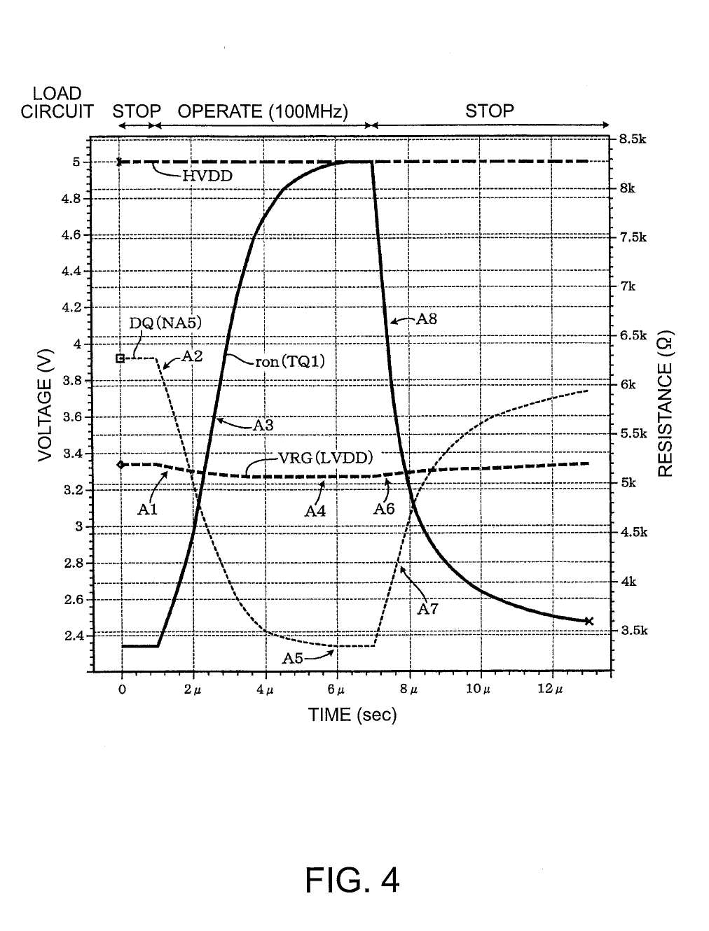

FIG. 4 shows a simulation result of the regulator circuit shown in FIG. 3. In FIG. 4, the power supply HVDD=5V. The load circuit (for example, 4000-gate circuit) coupled to the output terminal RQ of the regulator circuit stops operating (comes to rest) in a period 0 to 1 μs and a period 7 to 13 μs, while the load circuit operates at 100 MHz in periods 1 to 7 μs.

The load circuit stops operating in the period 0 to 1 μs, so the voltage of the output terminal DQ of the differential amplifier circuit 30 stabilizes at a voltage near the power supply HVDD. This increases the gate voltage of the n-type output transistor TQ1, thereby making the ON resistance ron of TQ1 a small value.

When one μs has elapsed and the load circuit starts to operate, rapid power consumption starts in the load circuit. However, the regulator circuit cannot follow this. A capacitor CS coupled to the output terminal RQ of the regulator circuit for stabilizing a voltage starts to discharge, thereby attempting to maintain the regulation voltage VRG (final power supply voltage LVDD).

When the capacitor continues to discharge electric charge and the regulator voltage VRG drops as indicated by A1 in FIG. 4, the voltage of the output terminal DQ of the differential amplifier circuit 30 starts to drop as indicated by A2 after a short delay from this rapid current consumption. This reduces the ON resistance of the p-type output transistor TQ2 as well as increases the ON resistance ron of the n-type output transistor TQ1 as indicated by A3.

Thereafter, when the regulation voltage VRG becomes a prescribed voltage as indicated by A4 in FIG. 4 due to the impedance of the load circuit and the ON resistance of the p-type output transistor TQ2, the voltage of the output terminal DQ ceases to change as indicated by A5.

When 7 μs has elapsed and the load circuit stops operating, the impedance of the load circuit rapidly increases. Therefore, the regulation voltage VRG increases as indicated by A6. At this time, the voltage of the output terminal DQ of the differential amplifier circuit 30 starts to increase as indicated by A7. This increases the ON resistance of the p-type output transistor TQ2 as well as reduces the ON resistance ron of the n-type output transistor TQ1 as indicated by A8. Thus, the increase of the voltage of the output terminal RQ of the regulator circuit is controlled.

As described above, in the regulator circuit according to this embodiment, when the load circuit starts to operate, the ON resistance ron of the n-type output transistor TQ1 is increased as indicated by A3 shown in FIG. 4. This reduces the current passing through the n-type output transistor TQ1, while this increases the current flowing from the HVDD to the load circuit. Thus, a larger amount of current can be supplied to the load circuit.

Further, when the load circuit stops to operate, the voltage of the output terminal DQ of the differential amplifier circuit 30 is increased as indicated by A7. This increases the ON resistance of the p-type output transistor TQ2, thereby reducing current consumption in the output circuit 40.

In this embodiment, in order to prevent the output circuit 40 from consuming unnecessary power, the size (W/L) of the p-type output transistor TQ2 is increased and that of the n-type output transistor TQ1 is reduced. Specifically, the size of the TQ1 is made one-tenth or less, more preferably one-fiftieth, that of TQ2. For example, if the size (W/L) of TQ2=1500, the size (W/L) of TQ1 is made, for example, 17.

3. Modifications

(1) First Modification

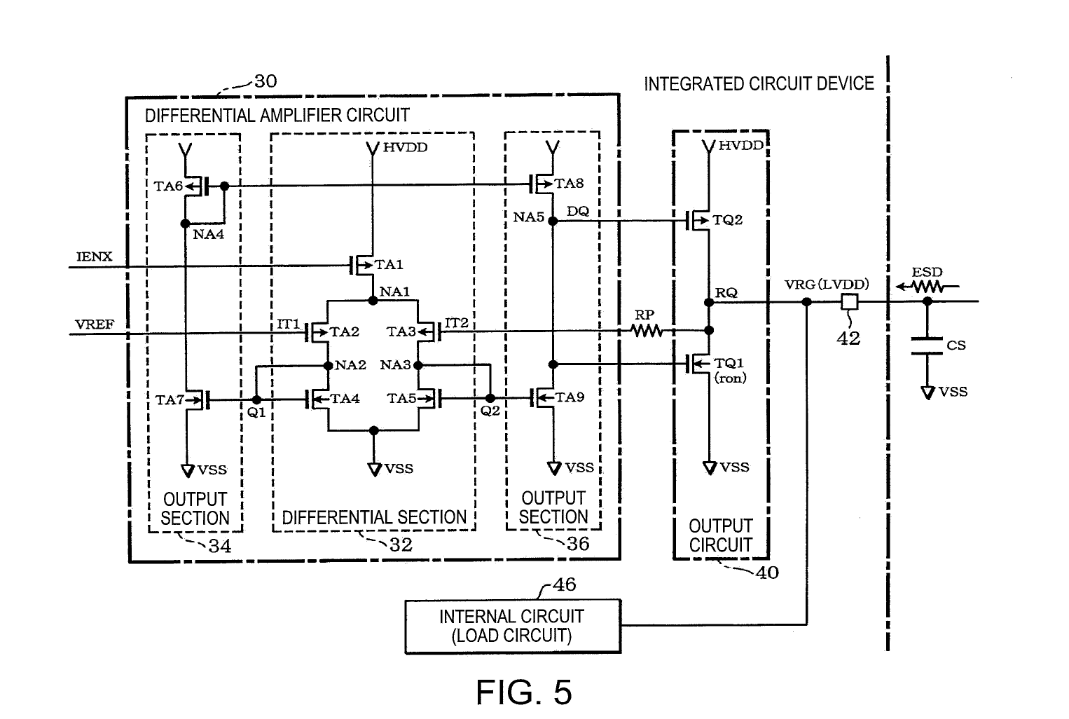

FIG. 5 shows a first modification of this embodiment. In FIG. 5, the regulator circuit includes a static-shielding resistive element RP provided between the input terminal IT2 and output terminal RQ. The resistive element RP can be realized, for example, using a well resistance.

In FIG. 5, an integrated circuit device includes the regulator circuit according to this embodiment and an internal circuit 46 (core circuit) that receives the regulation voltage VRG from the regulator circuit as the final power supply (LVDD) and operates on the regulation voltage. The internal circuit 46 can include, for example, a central processing unit (CPU), a real-time clock (RTC), a display driver, a memory, an interface circuit, various types of logic circuit, or the like. The integrated circuit also includes a pad 42 (external terminal) to which the output terminal of the regulator circuit is coupled. Coupled to the pad 42 is a capacitor CS for stabilizing the regulation voltage generated by the regulator circuit. Also coupled to the pad 42 is a power supply line (final power supply LVDD) of the internal circuit 46. Also, a modification can be made such that the capacitor CS is included in the integrated circuit.

The regulator circuit having the configuration shown in FIG. 5 is advantageous in that it is few in polarities count, is not apt to oscillate, and operates stably, while it is disadvantageous in that it responds at a low speed as indicated by A1, A4, and A6 shown in FIG. 4. In other words, it cannot immediately respond to rapid current consumption in the internal circuit 46 serving as a load circuit, that is, it responds slowly.

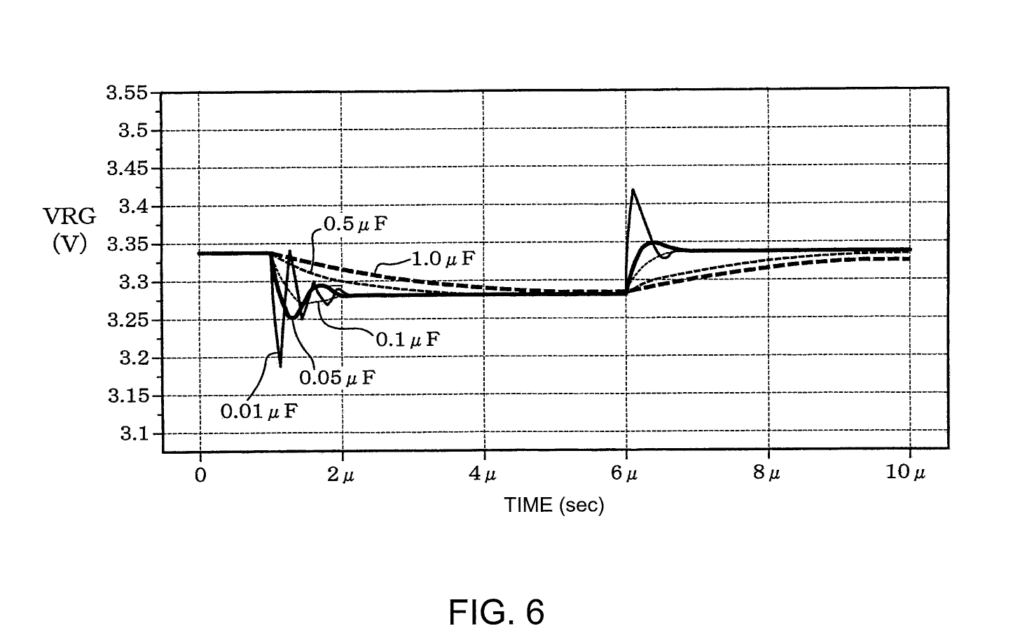

For this reason, in FIG. 5, the integrated circuit device includes the pad 42 serving as an external terminal to which the capacitor CS for stabilizing the regulation voltage VRG can be coupled. Coupling the capacitor CS in this manner allows the regulator circuit to cope with rapid current consumption in the internal circuit 46 by discharging electric charge from CS. For example, FIG. 6 shows a simulation result of the transient characteristic of the regulation voltage VRG when the capacitors CS with various capacities are used. As shown in FIG. 6, as the capacity of the capacitor CS is increased, the transient characteristic of the regulation voltage VRG is stabilized.

Incidentally, providing the pad 42 as shown in FIG. 5 causes a situation in which the output terminal RQ of the regulator circuit is subjected to external electrostatic discharge (ESD) via the pad 42. In this case, the p-type output transistor TQ2 is highly resistant to ESD thanks to its large transistor size as well as its large drain size. Also with regard to the n-type output transistor TQ1 whose transistor size is small, its ESD resistance can be improved by providing a static-shielding diode between the output terminal RQ and power supply VSS (GND).

However, this embodiment adopts the configuration in which the regulation voltage VRG directly returns to the input terminal IT2 of the differential amplifier circuit 30. As a result, the gate of the transistor TA3, which is the input terminal IT2, may be damaged by external ESD.

In this respect, providing the static-shielding resistive element RP between the output terminal RQ and the input terminal IT2 (gate of the transistor TA3) as shown in FIG. 5 can effectively prevent such electrostatic discharge damage.

(2) Second Modification

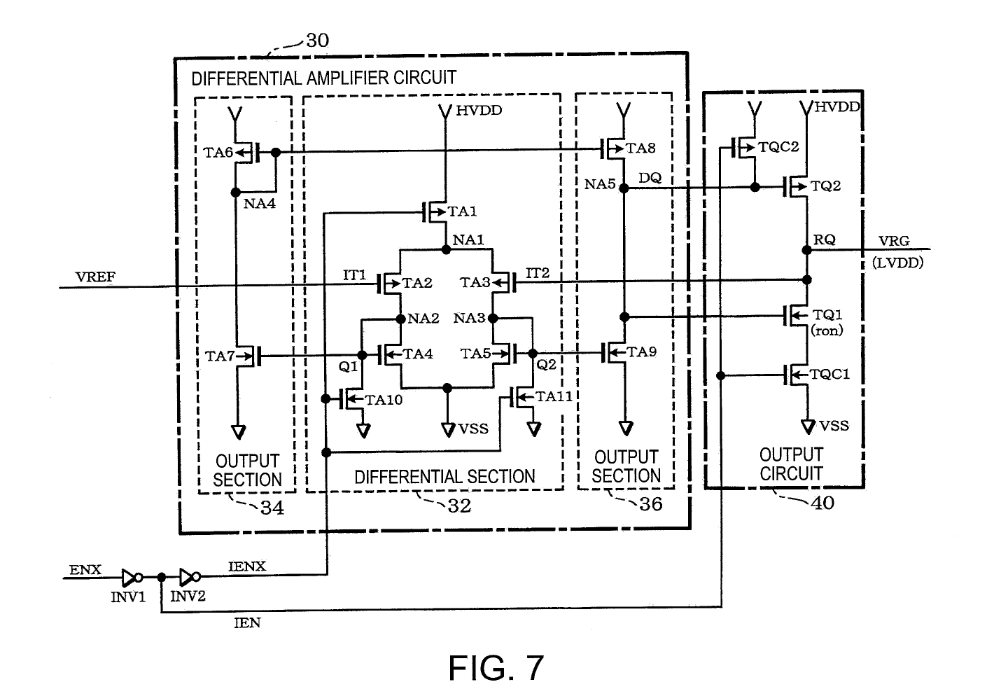

FIG. 7 shows a second modification of this embodiment. In FIG. 7, the differential section 32 includes an n-type transistor TA10 that is provided between the node NA2 and the power supply VSS and is turned on/off depending on a control signal ENX (IENX). It also includes an n-type transistor TA11 that is provided between the node NA3 and the power supply VSS and is turned on/off depending on the control signal ENX (IENX). “X” means negative logic.

The output circuit 40 includes an n-type transistor TQC1 for controlling output state that is provided between the output transistor TQ1 and the power supply VSS and is turned on/off depending on the control signal ENX (IEN). It also includes a p-type transistor TQC2 for controlling output state that is provided between the power supply HVDD and the output terminal DQ of the differential amplifier circuit 30 is turned on/off depending on the control signal ENX (IEN).

For example, if the control signal ENX becomes L level (active) and the regulator circuit is set to enabled, the signal IENX becomes L (low) level and the signal IEN becomes H (high) level. Therefore, the transistors TA10, TA11 and TQC2 are turned off, while the transistor TQC1 is turned on. This makes the circuit configuration shown in FIG. 7 equivalent to that shown in FIG. 3.

If the control signal ENX becomes H level (non-active) and the regulator circuit is set to disabled, the transistors TA10, TA11 and TQC2 are turned on, while the transistor TQC1 is turned off. When the transistors TA10 and TA11 are turned on, the nodes NA2 and NA3 (Q1, Q2) become L level. Therefore, the transistors TA4, TA5, TA7 and TA9 are turned off. As a result, the current passing through the differential section 32 and the output sections 34 and 36 can be interrupted, thereby reducing power consumption.

If the transistor TQC2 is turned on, the node 5 (DQ) becomes H level and the transistor TQ2 is turned off. Therefore, the current passing from the power supply HVDD via the transistor TQ2 can be interrupted. If the transistor TQC1 is turned off, the current passing from the output terminal RQ to the power supply VSS can be interrupted. As a result, the current passing through the output circuit 40 can be interrupted, thereby reducing power consumption.

Turning off the output-state controlling transistor TQC1 allows the output terminal RQ of the regulator circuit to be set to high impedance state.

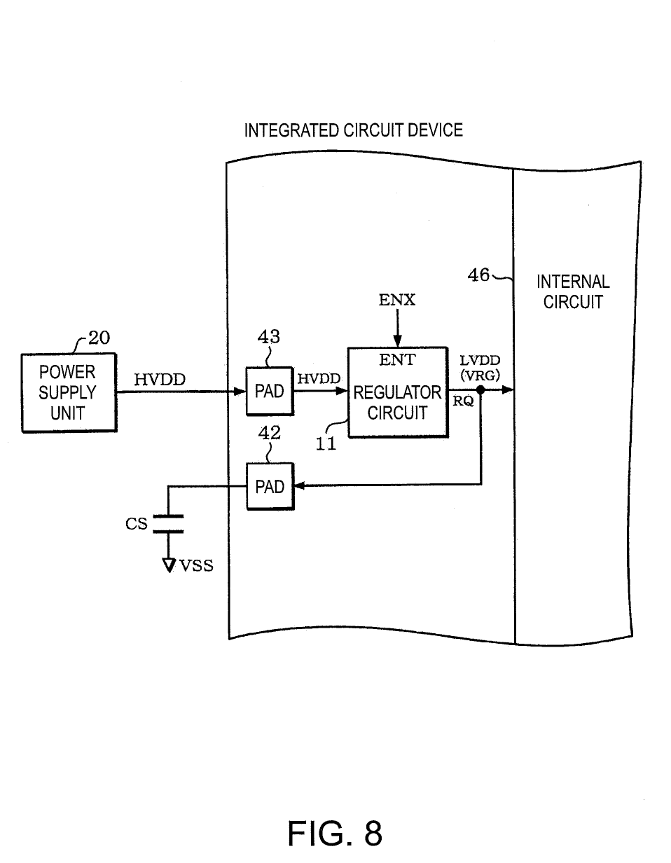

For example, in FIG. 8, the voltage of the power supply HVDD (high voltage power supply) is supplied from an external power supply section 20 to the integrated circuit device. The regulator circuit 11 that has received this voltage generates the voltage (VRG) of the final power supply LVDD (low voltage power supply) and supplies the final power supply voltage to the internal circuit 46. The output terminal of the regulator circuit 11 is coupled to the external capacitor CS via the pad 42.

Also in FIG. 8, the state of the output terminal RQ of the regulator circuit 11 is controlled by the control signal ENX. In this case, the control signal ENX may be a signal inputted from the outside via a pad, or a signal inputted from a control circuit (a circuit that operates on a power supply other than the final power supply LVDD) provided inside the integrated circuit device.

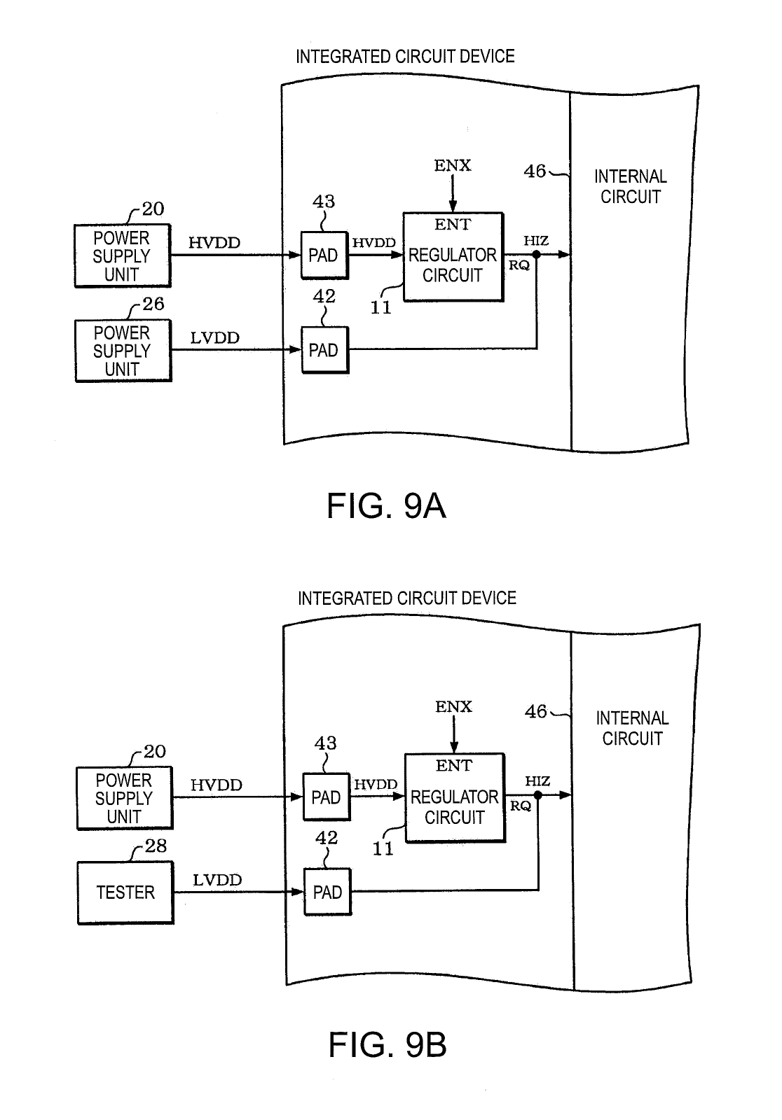

In FIG. 7, if the control signal ENX becomes H level, the output-state controlling transistor TQC1 is turned off and the output terminal RQ is put in high impedance state. Putting the output terminal RQ of the regulator circuit 11 into high impedance state in this manner allows the final power supply LVDD from the external power supply section 26 to be directly supplied to the internal circuit 46, thereby operating the internal circuit 46, as shown in FIG. 9A.

For example, if the integrated circuit device according to this embodiment is applied to a custom product, a customer purchasing the custom product may want to supply a final power supply LVDD from the external power supply section 26 rather than generating a final power supply LVDD in the regulator circuit 11. Specifically, assume that the regulator circuit 11 is a circuit to a specification in which a power supply voltage HVDD of 5 V is stepped down to a final power supply voltage LVDD (regulation voltage VRG) of 3.3 V. However, the customer may want to cause the internal circuit 46 to operate on a voltage of 2.5 V rather than on a voltage of 3.3V in order to reduce power consumption. In this case, the control signal ENX is made H level to put the output terminal RQ of the regulator circuit 11 into high impedance state, as shown in FIG. 9A. This allows the final power supply LVDD from the power supply section 26 to be directly supplied to the internal circuit 46 via the pad 42, thereby responding to demands from a wide variety of customers.

If the integrated circuit device is set to test mode to test the internal circuit 46, it is not desirable to supply the voltage of the final power supply LVDD generated by the regulator circuit 11 to the internal circuit 46. Therefore, in such a test mode, the control signal ENX is made H level to put the output terminal RQ of the regulator circuit 11 into high impedance state, as shown in FIG. 9B. Then a final power supply LVDD from a tester 28 (power supply unit) is directly supplied to the internal circuit via the pad 42. This allows the internal circuit 46 to be tested without being affected by an error in the voltage of the final power supply LVDD generated by the regulator circuit 11, thereby enhancing reliability of the test.

(3) Third Modification

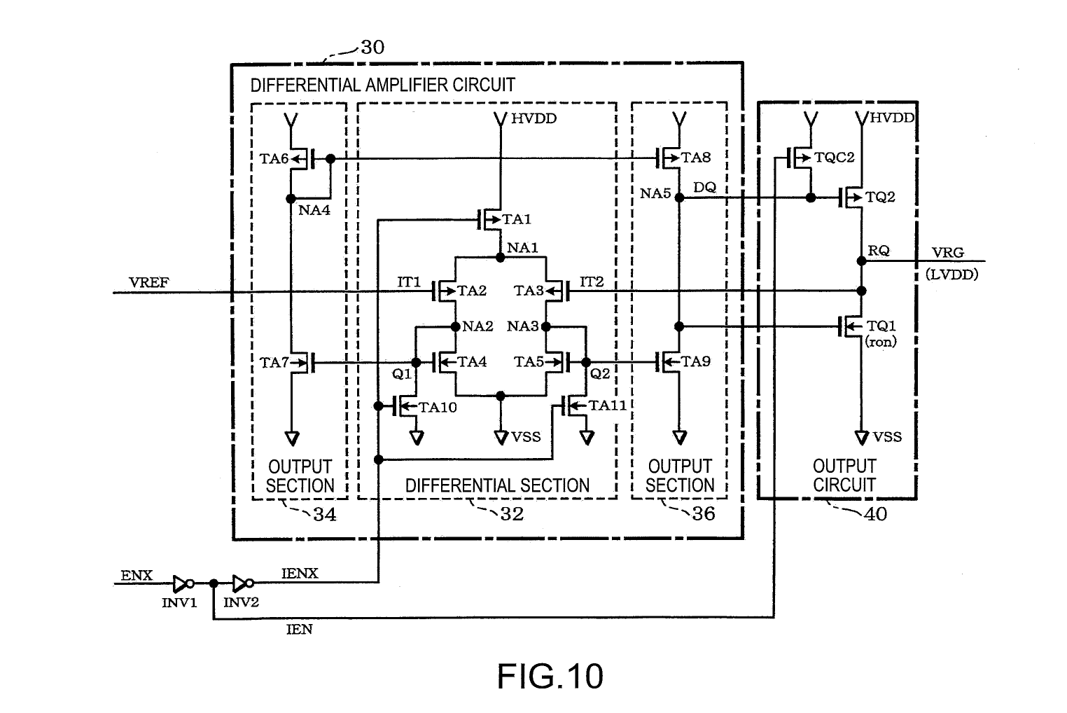

FIG. 10 shows a third modification according to this embodiment. In the configuration shown in FIG. 10, the output-state controlling transistor TQC1 provided in FIG. 7 is not provided.

In FIG. 10, if the control signal ENX is made H level, the output-state controlling transistor TQC2 is turned on and the node NA5 is made H level. Then the output transistor TQ2 is turned off, while the output transistor TQ1 is turned on. This allows the state (voltage level) of the output terminal RQ of the regulator circuit to be set to L level.

If the signal ENX is set to H level and the output terminal RQ of the regulator circuit is set to L level, no power is supplied to the internal circuit coupled to RQ. This allows the internal circuit to be set to low power consumption mode (sleep mode). If the signal is set to H level, the transistors TA10 and TA11 shown in FIG. 10 are turned on. Therefore, the regulator circuit can also be set to low power consumption mode (sleep mode). As a result, according to the third embodiment shown in FIG. 10, simply controlling the signal ENX allows both the regulator circuit and the internal circuit receiving the power supplied by the regulator circuit to be set to low power consumption mode. This makes it possible to realize low power consumption mode using simplified control.

(4) Fourth Modification

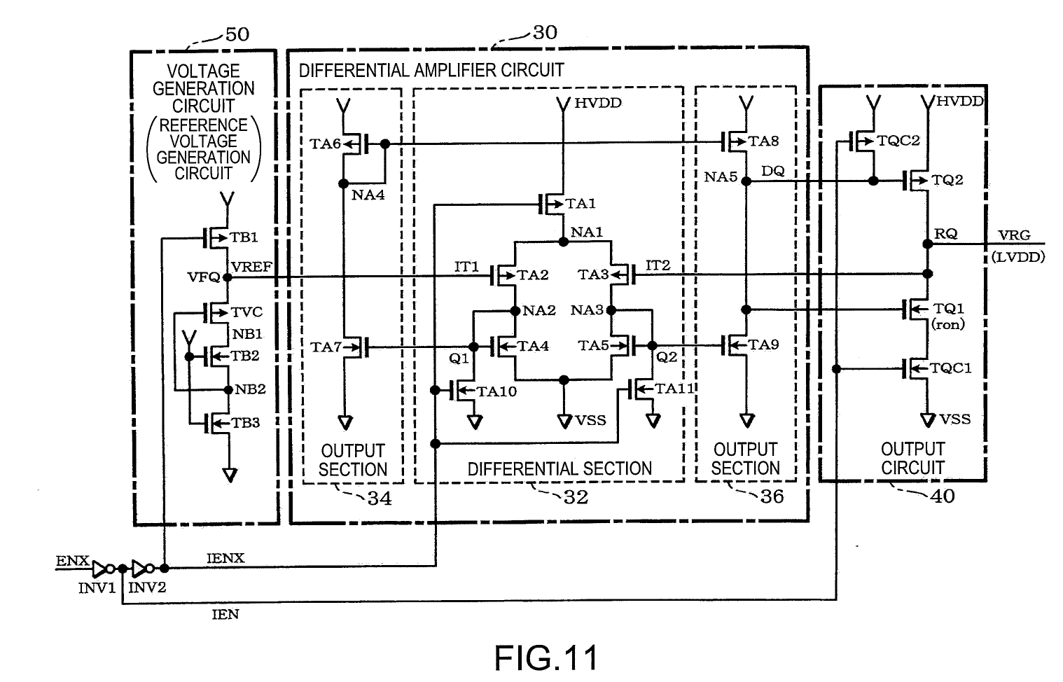

FIG. 11 shows a fourth modification according to this embodiment. The configuration shown in FIG. 11 includes a voltage generation circuit 50 (reference voltage generation circuit) for generating a reference voltage VREF in addition to the configuration shown in FIG. 7.

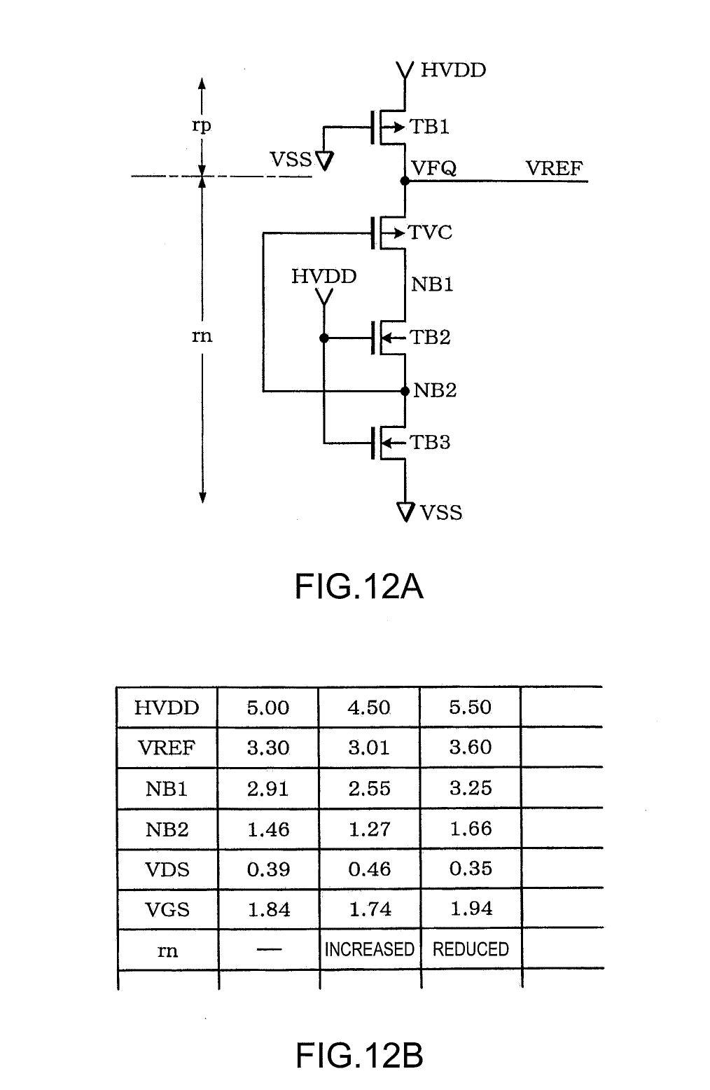

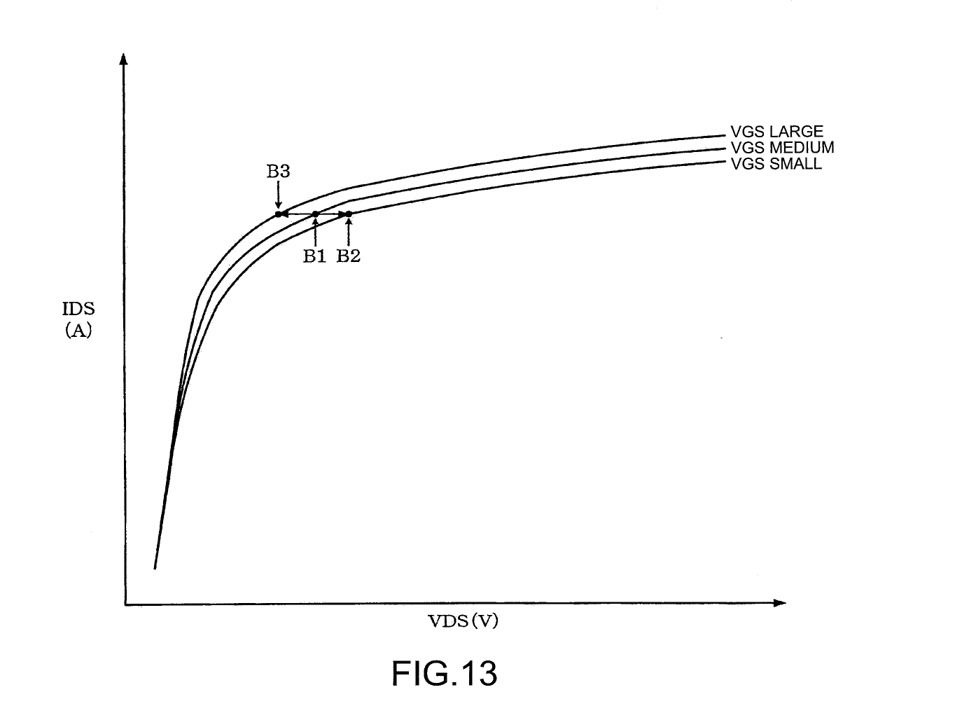

Referring now to FIGS. 12A, 12B, and 13, the configuration and operation of the voltage generation circuit 50 will be described. The voltage generating circuit 50 is a circuit for receiving the power supplies HVDD and VSS (first and second power supplies) and outputting the reference voltage VREF (“generated voltage” as a broader term) to the output terminal VFQ. It includes a p-type (second conductivity type) transistor TB1 (“first resistive element” as a broader term) provided between the power supply HVDD and an output terminal VFQ. It also includes a p-type (second conductivity type) transistor TVC for correcting voltage that is provided between the output terminal VFQ and an intermediate node NB1 and to whose gate an intermediate mode NB2 is coupled. It also includes an n-type (first conductivity type) transistor TB2 (“second resistive element” as a broader term) that is provided between the intermediate node NB1 and the intermediate node NB2 and an n-type (first conductivity type) transistor TB3 (“third resistive element” as a broader term) that is provided between the intermediate node NB2 and the power supply VSS.

Here, TB2 and TB3 are n-type transistors to whose gate the voltage of the power supply HVDD is inputted. TB1 is a p-type transistor to whose gate the voltage of the power supply VSS is inputted. As shown in FIG. 11, TB1 may be a transistor whose gate voltage is controlled by the control signal ENX (IENX).

As shown in FIG. 12B, if the voltage of the power supply HVDD is 5.00 V, the reference voltage and the voltages of NB1 and NB2 become, for example, 3.30V, 2.91V, and 1.46 V, respectively. Therefore, the drain-source voltage VDS (absolute value) of the voltage correcting transistor TVC becomes 3.30−2.91=0.39 V, and the gate-source voltage VGS (absolute value) of the transistor TVC becomes 3.30−1.46=1.84V.

As shown in FIG. 12B, if the voltage of the power supply HVDD is dropped from 5.00 V to 4.50 V, the reference voltage and the voltages of NB1 and NB2 become, for example, 3.01 V, 2.55 V, and 1.27 V, respectively. Therefore, the drain-source voltage VDS of the voltage correcting transistor TVC becomes 3.01−2.55=0.46 V, and the gate-source voltage VGS of the transistor TVC becomes 3.01−1.27=1.74 V.

For example, FIG. 13 shows the VDS-IDS characteristic of the transistor TVC. When the voltage of the power supply HVDD is dropped from 5.00 V to 4.50 V, the operation point of the transistor TVC moves from B1 to B2. In other words, assuming that the drain-source current IDS is constant, VDS is increased from the 0.39 V to 0.46 V and VGS is reduced from 1.84 V to 1.74 V, as shown in FIG. 12B. This means that the operation point has moved from B1 to B2.

When VGS of the transistor TVC is reduced from 1.84 V to 1.74 V, the ON resistance of TVC is increased. Then, in FIG. 12A, a resistance rn that is the total sum of the ON resistances of the transistors TVC, TB2, and TB2 is also increased. Such an increase in the resistance rn means that the reference voltage VREF that is about to be reduced due to the drop of the power supply HVDD returns to the voltage prior to the drop of the power supply HVDD thanks to voltage correction. In other words, the voltage correction made by the transistor TVC renders the voltage drop of the reference voltage VREF smaller than the voltage drop of the power supply HVDD. As a result, the variation in voltage of the reference voltage VREF can be confined within −10% of 3.30 V relative to the variation in voltage of the power supply HVDD from 5.00 V to 4.50 V.

As shown in FIG. 12B, when the voltage of the power supply HVDD is increased from 5.00 V to 5.50 V, the reference voltage VREF and the voltages of NB1 and NB2 become, for example, 3.60 V, 3.25 V, and 1.66 V. As a result, the drain-source voltage VDS (absolute value) of the voltage correcting transistor TVC becomes 3.60−3.25=0.35 V, and the gate-source voltage VGS (absolute value) of the transistor TVC becomes 3.60−1.66=1.94 V.

For example, in FIG. 13, if the voltage of the power supply HVDD is increased from 5.00 V to 5.50 V, the operation point of the transistor TVC moves from B1 to B3. In other words, assuming that the drain-source current IDS is constant, VDS is reduced from the 0.39 V to 0.35 V and VGS is increased from 1.84 V to 1.94 V, as shown in FIG. 12B. This means that the operation point has moved from B1 to B3 in FIG. 13.

When VGS of the transistor TVC is reduced from 1.84 V to 1.94 V, the ON resistance of TVC is reduced. Then, in FIG. 12A, the resistance rn, which is the total sum of the ON resistances of the transistors TVC, TB2, and TB2, is also reduced. Such a reduction in the resistance rn means that the reference voltage VREF that is about to be increased due to the increase of the power supply HVDD returns to the voltage prior to the drop of the power supply HVDD thanks to voltage correction. In other words, the voltage correction made by the transistor TVC renders the voltage increase of the reference voltage VREF smaller than the voltage increase of the power supply HVDD. As a result, the variation in the reference voltage VREF can be confined within +10% of 3.30 V relative to the variation in the power supply voltage HVDD from 5.00 V to 5.50 V. Eventually, the variation in the reference voltage VREF can be confined within +/−10% of 3.30 V.

As described above, according to FIG. 12A, a voltage generation circuit that has a simplified configuration in which circuit elements are few in number but can generate the reference voltage VREF with some degree of accuracy can be realized.

Further, according to the voltage generation circuit shown in FIG. 12A, the reference voltage VREF that is the regulation target of the regulation voltage VRG can be generated. For example, the voltage of the power supply HVDD is 5.0 V, the reference voltage VREF of 3.3 V can be generated. As a result, as shown in FIG. 11, a voltage generation circuit that is optimally combined with the regulator circuit according to this embodiment can be realized.

Incidentally, in the regulator circuit shown in FIG. 11, a voltage equivalent to the reference voltage VREF is outputted as the regulation voltage VRG. Therefore, if the voltage of the reference voltage VREF is as low as 1.2 to 1.4-V, the regulation voltage VRG outputted from the regulator circuit also becomes as low as 1.2 to 1.4 V.

On the other hand, in the voltage generation circuit shown in FIG. 12A, the reference voltage VREF of, for example, 3.3 V can be generated. Therefore, if the voltage generation circuit shown in FIG. 12A is combined with the regulator circuit according to this embodiment, the regulation voltage VRG outputted from the regulator circuit can be set to, for example, 3.3 V. This allows a preferable regulation voltage VRG to be supplied to the internal circuit in the integrated circuit device.

In FIG. 11, the voltage of the gate of the transistor TB1 is controlled by the control signal ENX (IENX). Specifically, if the control signal ENX becomes L level, the transistor TB1 is turned on, and if ENX becomes H level, the transistor TB1 is turned off. If the transistor TB1 is turned off, the current passing through the voltage generation circuit 50 can be interrupted, thereby realizing low power consumption mode (sleep mode). In other words, simply making the control signal ENX H level allows all of the voltage generation circuit, the regulator circuit, and the internal circuit to be set to low power consumption mode.

(5) Fifth Modification

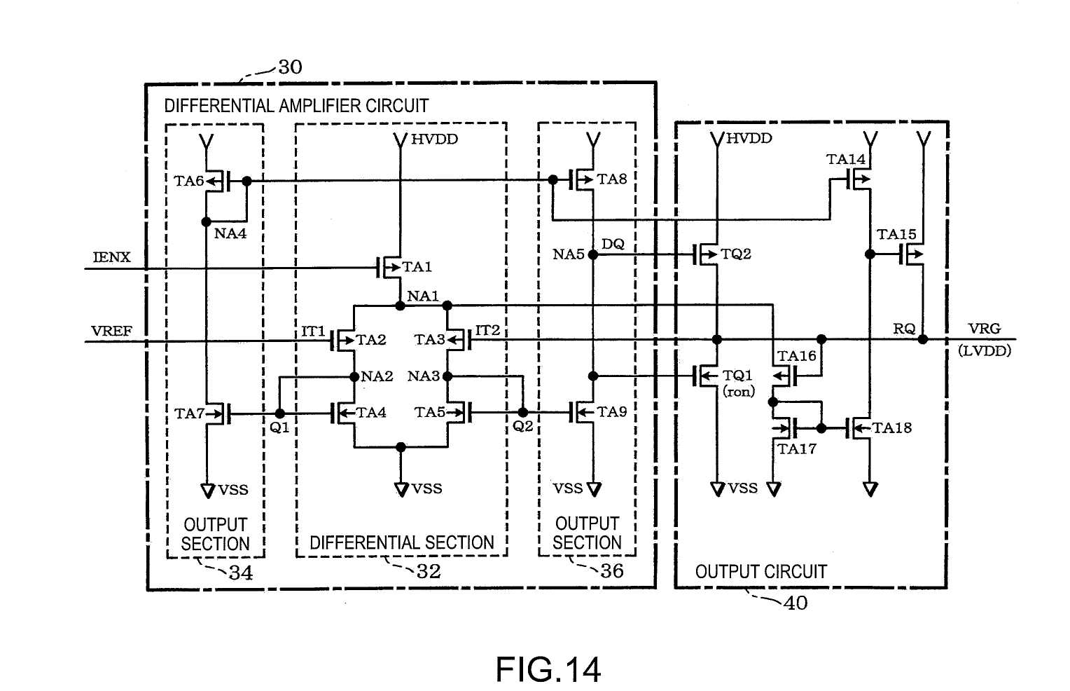

FIG. 14 shows a fifth modification of this embodiment. The configuration shown in FIG. 14 includes p-type transistors TA14, TA15, and TA16 and n-type transistors TA17 and TA18 in addition to the configuration shown in FIG. 7. Coupled to the gate of the transistor TA14 is a node NA5. Coupled to the gate of the transistor TA15 is the drain of TA14. Coupled to the drain of the transistor TA15 is the output terminal RQ. Coupled to the gate of the transistor TA16 is the output terminal RQ. Coupled to the gate and drain of the transistor TA17 is the drain of TA16. Coupled to the gate of the transistor TA18 is the drain of TA16. Coupled to the drain of the transistor TA18 is the drain of TA14.

For example, in FIG. 7, if power consumption in the load circuit coupled to RQ is high, the size of the transistor TQ2 must be increased so as to enhance its capability. However, if the size of the transistor TQ2 is increased and its gate capacity is increased, the load under which the differential amplifier circuit 30 should be driven is increased, thereby causing the regulator circuit to respond at a lower speed.

In this regard, according to the configuration shown in FIG. 14, the transistor TA15 of a small size is provided in parallel to the output transistor TQ2, and the gate of the transistor TA15 is controlled by the transistors TA16, TA17, TA18 and the like. This makes it possible to improve the response characteristic (follow-up characteristic) of the regulator circuit.

(6) Sixth Modification

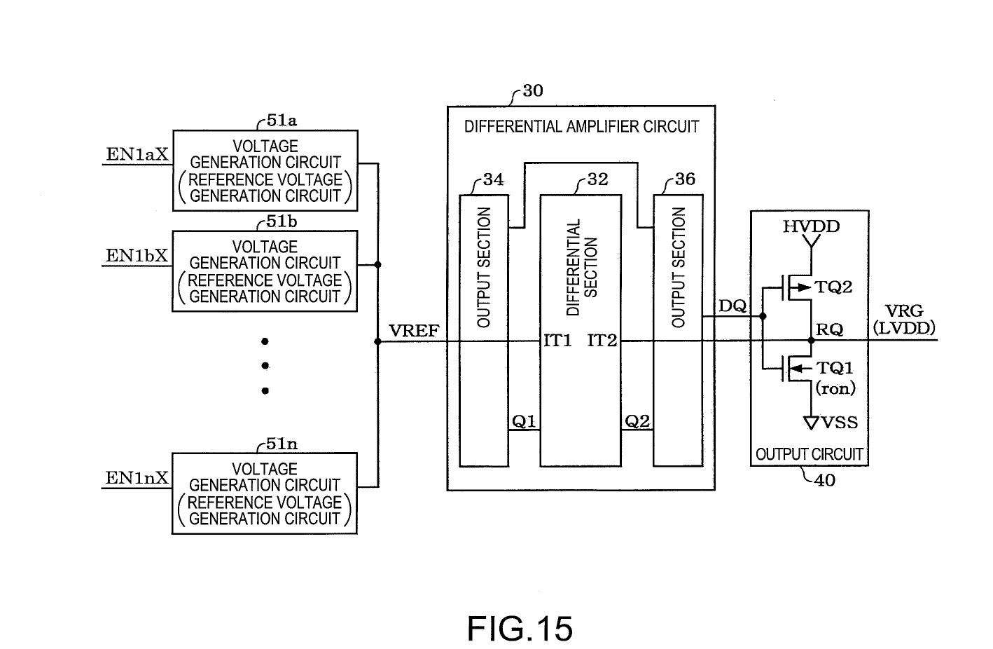

FIG. 15 shows a sixth modification of this embodiment. The configuration shown in FIG. 15 includes a plurality of voltage generation circuits (reference voltage generation circuits) 51a to 51n for generating the reference voltage VREF in addition to the configuration shown in FIG. 1.

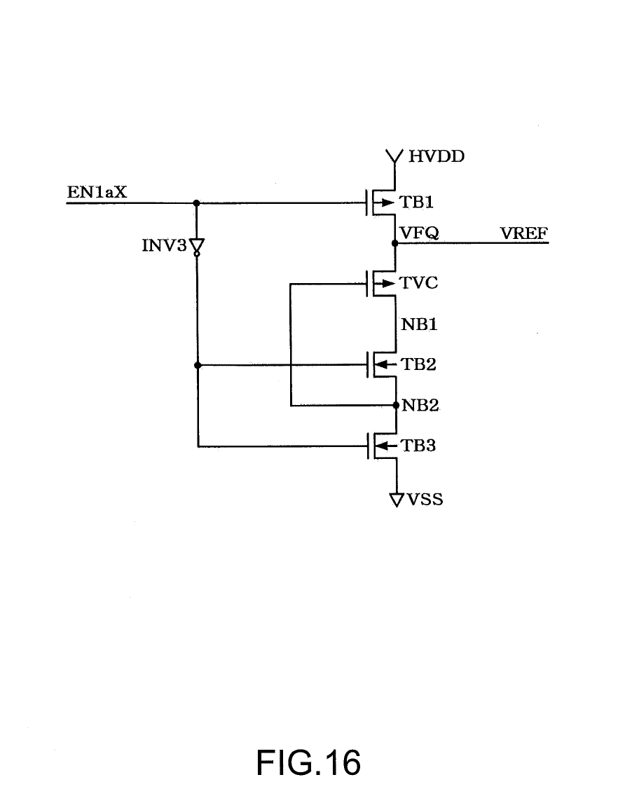

Referring now to FIG. 16, the configuration and operation of the voltage generation circuit 51a will be described. The voltage generation circuit 51a is a circuit for receiving the power supplies HVDD and VSS (first and second power supplies) and outputting the reference voltage VREF (“generated voltage” as a broader term) to the output terminal VFQ. The voltage generation circuit 51a includes a p-type (second conductivity type) transistor TB1 provided between the power supply HVDD and output terminal VFQ. It also includes a p-type voltage correcting transistor TVC that is provided between the output terminal VFQ and the intermediate node NB1 and to whose gate the intermediate node NB2 is coupled. It also includes an n-type (first conductivity type) transistor TB2 (“second resistive element” as a broader term) provided between the intermediate nodes NB1 and NB2 and an n-type transistor TB3 (“third resistive element” as a broader term) provided between the intermediate node NB2 and the power supply VSS.

Here, TB1 is a p-type transistor to whose gate the control signal EN1aX (X means negative logic) is inputted. TB2 and TB3 are n-type transistors to whose gate a signal obtained by inverting the control signal EN1aX by an inverter INV3 is inputted.

When the control signal EN1aX becomes L level (active), the transistors TB1, TB2, and TB3 are turned on, whereby the reference voltage VREF is outputted from the output terminal VFQ. On the other hand, when the control signal EN1aX becomes H level (non-active), the transistors TB1, TB2, and TB3 are turned off, whereby the output terminal VFQ is put into high impedance state.

The configurations of the other voltage generation circuits 51b to 51n are similar to that of the voltage generation circuit 51a shown in FIG. 16.

Referring again to FIG. 15, the output terminals of the voltage generation circuits 51a to 51n are coupled to the first input terminal IT1 of the differential amplifier circuit 30 via wiring. Here, making any one of the control signals EN1aX to EN1nX supplied to the voltage generation circuits 51a to 51n, respectively, L level (active) and making the others H level (non-active) allows the reference voltage VREF outputted by any one of the voltage generation circuits 51a to 51n to be supplied to the first input terminal IT1 of the differential amplifier circuit 30.

In the process of manufacturing the regulator circuit, variations may occur in the characteristics of the transistors included in the voltage generation circuits 51a to 51n. As a result, variations may occur in the voltages generated by the voltage generation circuits 51a to 51n. Further, as the regulator circuit is used, the transistors included in the voltage generation circuits 51a to 51n may deteriorate, whereby a variation may occur in the voltages generated by the voltage generation circuits 51a to 51n. In such a case, it is possible to generate a voltage nearest a desired regulation voltage VRG by making any one of the control signal EN1aX to EN1nX L level (active) and making the others H level (non-active) so that one of the voltage generation circuits 51a to 51n that outputs a voltage nearest a desired reference voltage VREF will operate and the other voltage generation circuits will not operate.

Since any one of the voltage generation circuits 51a to 51n generates a voltage and the others are put into high impedance state, the output voltages of the voltage generation circuits 51a to 51n will not compete against one another.

(7) Seventh Modification

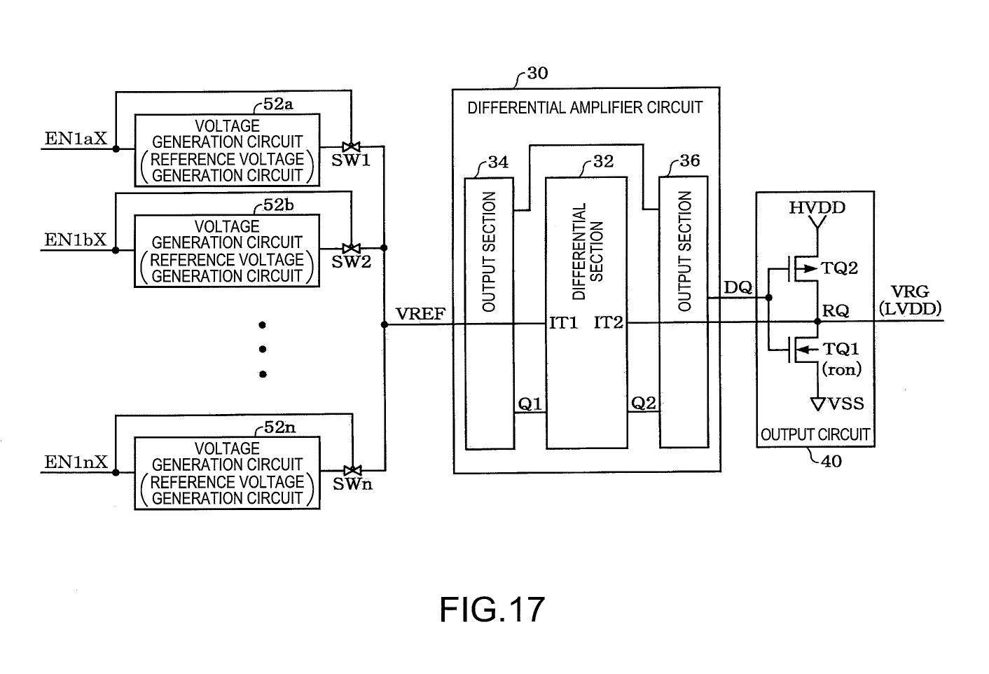

FIG. 17 shows a seventh modification of this embodiment. The configuration shown in FIG. 17 includes a plurality of voltage generation circuits (reference voltage generation circuits) 52a to 52n for generating the reference voltage VREF and n-pieces of switch circuits SW1 to SWn in addition to the configuration shown in FIG. 1.

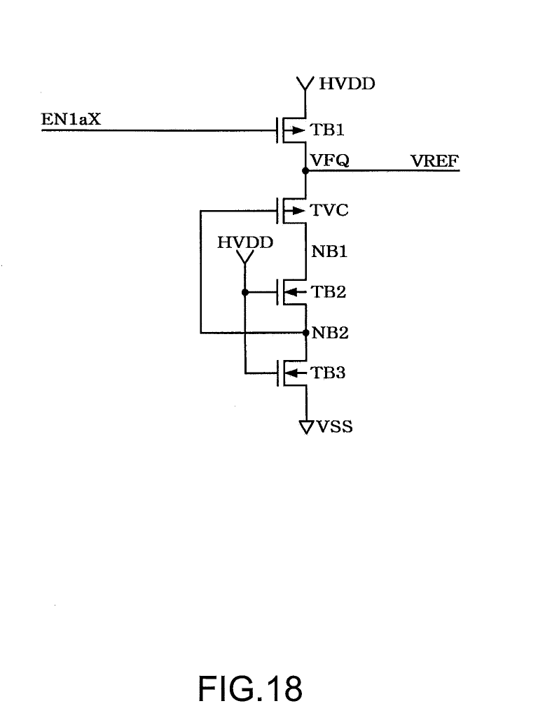

Referring now to FIG. 18, the configuration and operation of the voltage generation circuit 52a will be described. The voltage generation circuit 52a is a circuit for receiving the power supplies HVDD and VSS (first and second power supplies) and outputting the reference voltage VREF (“generated voltage” as a broader term) to the output terminal VFQ. The voltage generation circuit 52a includes a p-type (second conductivity type) transistor TB1 provided between the power supply HVDD and output terminal VFQ. It also includes a p-type voltage correcting transistor TVC that is provided between the output terminal VFQ and the intermediate node NB1 and to whose gate the intermediate node NB2 is coupled. It also includes an n-type (first conductivity type) transistor TB2 (“second resistive element” as a broader term) provided between the intermediate nodes NB1 and NB2 and an n-type transistor TB3 (“third resistive element” as a broader term) provided between the intermediate node NB2 and the power supply VSS.

Here, TB1 is a p-type transistor to whose gate the control signal EN1aX (X means negative logic) is inputted. TB2 and TB3 are n-type transistors to whose gate the power supply HVDD is inputted.

When the control signal EN1aX becomes L level (active), the transistor TB1 is turned on, whereby the reference voltage VREF is outputted from the output terminal VFQ. On the other hand, when the control signal EN1aX is H level (non-active), the transistor TB1 is turned off, whereby the output terminal VFQ becomes L level.

The configurations of the other voltage generation circuits 52b to 52n are similar to that of the voltage generation circuit 52a shown in FIG. 18.

Referring again to FIG. 17, the output terminals of the voltage generation circuits 52a to 52n are each coupled to the first input terminal IT1 of the differential amplifier circuit 30 via the switches SW1 to SWn, respectively. Inputted into the control input terminals of the switches SW1 to SWn are the control signals EN1aX to EN1nX, respectively. The switches SW1 to SWn are turned on when the control signals EN1aX to EN1nX, respectively, become L level (active), and are turned off when the control signals EN1aX to EN1nX, respectively, become H level (non-active).

In FIG. 17, making any one of the control signal EN1aX to EN1nX L level (active) and making the others H level (non-active) allows the reference voltage VREF outputted by any one of the voltage generation circuits 52a to 52n to be supplied to the first input terminal IT1 of the differential amplifier circuit 30 via any one of the switches SW1 to SWn.

In the process of manufacturing the regulator circuit, variations may occur in the characteristics of the transistors included in the voltage generation circuits 52a to 52n. Further, as the regulator circuit is used, the transistors included in the voltage generation circuits 52a to 52n may deteriorate, whereby a variation may occur in the voltages generated by the voltage generation circuits 52a to 52n. In such a case, it is possible to generate a voltage nearest a desired regulation voltage VRG by making any one of the control signal EN1aX to EN1nX L level (active) and making the others the H level (non-active) so that one of the voltage generation circuits 52a to 52n that outputs a voltage nearest a desired reference voltage VREF will supply its voltage to the differential amplifier circuit 30 and the other voltage generation circuits will not supply their voltages to the differential amplifier circuit 30.

In the previously described sixth modification, when the control signals EN1aX to EN1nX become H level (non-active), the output terminals of the voltage generation circuits 51a to 51n are put into high impedance state. Therefore, the output terminals of the voltage generation circuits 51a to 51n are directly coupled to the first input terminal IT1 of the differential amplifier circuit 30 via the wiring without causing the voltages of the voltage generation circuits 51a to 51n to compete against one another. On the other hand, in this modification, when the control signals EN1aX to EN1nX become H level (non-active), the output terminals of the voltage generation circuits 52a to 52n are made L level. As a result, the output terminals of the voltage generation circuits 52a to 52n cannot be directly coupled to the first input terminal IT1 of the differential amplifier circuit 30 via wiring. Therefore, in this modification, the output terminals of the voltage generation circuits 52a to 52n are coupled to the first input terminal IT1 of the differential amplifier circuit 30 via the switches SW1 to SWn. This prevents the output voltages of the voltage generation circuits 52a to 52n from competing against one another.

While in this modification the switches SW1 to SWn are provided between the output terminals of the voltage generation circuits 52a to 52n and the first input terminal IT1 of the differential amplifier circuits 30, a modification can be made such that fuses are used instead of the switches SW1 to SWn. Also, a modification can be made such that a piece of wiring coupling between one of the voltage generation circuits 52a to 52n and the first input terminal IT1 of the differential amplifier circuits 30 is left intact and pieces of wiring coupling between the other voltage generation circuits and the first input terminal IT1 of the differential amplifier circuits 30 is laser-trimmed without providing the switches SW1 to SWn.

4. Integrated Circuit Device

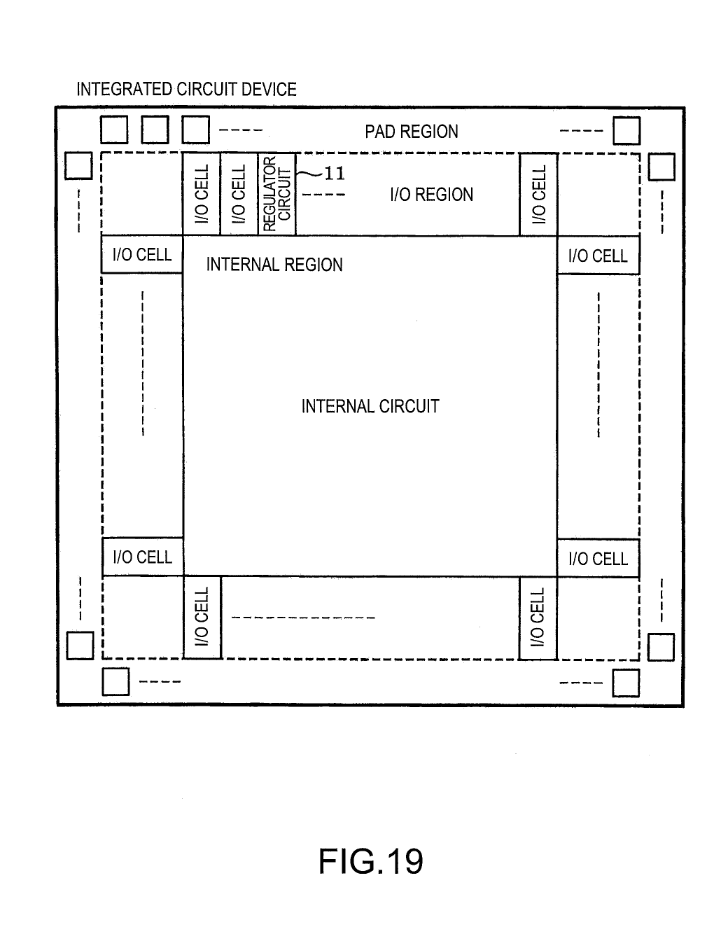

FIG. 19 shows an example of an integrated circuit device including the regulator circuit according to this embodiment. The integrated circuit device shown in FIG. 19 is applicable to products such as gate arrays, embedded arrays, and the like.

The integrated circuit device includes an internal region (core region) and an I/O region. It also includes a pad region. Here, the I/O region is formed outside the internal region. Specifically the I/O region is formed so as to enclose the perimeter (four edges) of the internal region. The pad region is formed outside the I/O region. Specifically the pad region is formed so as to enclose the perimeter (four edges) of the I/O region. A pad may be disposed in the I/O region or the like rather than in the pad region. In this case, it is not necessary to provide a pad region.

Formed in the internal region is an internal circuit (core circuit) of the integrated circuit device. The internal circuit can includes a CPU, an RTC, a display driver, a memory, an interface circuit, or various types of logic circuits.

Disposed in the I/O region are a plurality of I/O cells (input buffer, output buffer, I/O buffer, a power supply cell, etc). Specifically, for example, a plurality of I/O cells are disposed in line so as to enclose the perimeter (each edge) of the internal circuit. Disposed in the pad region are pads coupled to the I/O cells. Disposition of the internal region, I/O region, and/or pad region, and/or disposition of the I/O cells and/or the pads are not limited to that shown in FIG. 19 and various modifications can be made thereto.

As shown in FIG. 19, in this embodiment, the regulator circuit 11 (power supply circuit) is formed (disposed) in the I/O region of the integrated circuit. Specifically the regulator circuit 11 is disposed as one of the I/O cells. In other words, the regulator circuit 11 is formed into a cell and disposed in the I/O region. In this case, for example, the cell of the regulator circuit 11 can be of a size similar to those of the I/O cells (at least one of the plurality of I/O cells).

A plurality of regulator circuits may be formed in the I/O region, and the plurality of regulator circuits may supply regulation voltages in parallel to the internal circuit. Further, if the internal circuit includes a plurality of circuit blocks (CPU, RTC, memory, etc.), at least one of the regulator circuits may supply a regulation voltage (final power supply voltage LVDD) to each of the circuit blocks. Furthermore, if the internal circuit includes a plurality of well regions, at least one of the regulator circuits may supply a regulation voltage (final power supply voltage LVDD) to each of the well regions.

As a comparative example of a technique for disposing a power circuit, such as the regulator circuit 11, in an integrated circuit device, a technique for forming a power supply into a macroblock and disposing the macro-block at a corner of the integrated circuit device or disposing the macroblock in a region including a part of the I/O region is conceivable.

However, according to this comparative example, there occurs a limitation in pin arrangement, thereby making it difficult to secure flexibility in pin arrangement for a customer of a custom product.

On the other hand, the technique according to this embodiment shown FIG. 19 allows the regulator circuit 11 to be disposed in an arbitrary position of the I/O region. This makes it possible to secure flexibility in pin arrangement for a customer of a custom product, thereby improving marketability.

In this embodiment, the internal circuit includes a low-voltage transistor (a transistor whose withstand voltage is a first voltage) and the regulator circuit 11 includes a high voltage transistor (a transistor whose withstand voltage is a second voltage higher than the first voltage). In other words, the internal circuit is formed in a low voltage region in which a low voltage transistor is disposed and the regulator circuit 11 (I/O cell) is formed in a high voltage region in which a high voltage region is disposed. Here, a low voltage transistor is a transistor whose maximum rating (absolute maximum rating) is lower than that of a high voltage transistor. A high voltage transistor is a transistor whose maximum rating (absolute maximum rating) is higher than that of a low voltage transistor. Specifically a high transistor is, for example, a transistor whose gate oxide film is thicker than that of a low voltage transistor.

Incidentally the output terminal RQ of the regulator circuit is coupled to the pad 42 so that the capacitor CD or the like is coupled to the output terminal RQ. As a result, the transistors (TQ1, TQ2, TA3, and the like) of the regulator circuit are directly subjected to external ESD (static electricity) via the pad 42, whereby these transistors may be damaged by the ESD.

In this regard, the regulator circuit according to this embodiment can be made highly resistant to ESD because it includes a high voltage transistor as with an I/O cell. Effectively utilizing a static-shielding element (static-shielding diode, static-shielding resistive element, etc.) formed in the high voltage region also allows the ESD resistance of the regulator circuit to be enhanced. This can effectively prevent these transistors from being damaged by EDS, thereby improving reliability.

The regulator circuit according to this embodiment is a circuit for generating a low voltage power supply (LVDD) from a high voltage power supply (HVDD). Also in this regard, the configuration in which the regulator circuit includes a high voltage transistor (a transistor that operates on HVDD) is advantageous.

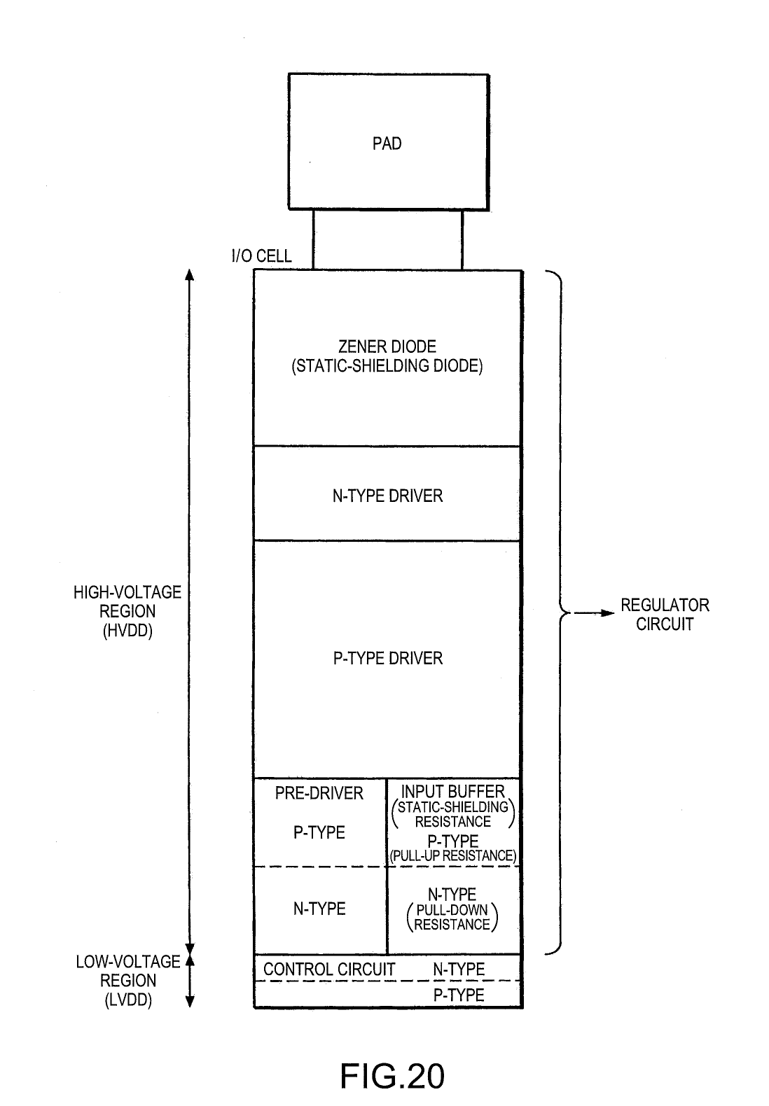

FIG. 20 shows a layout example of an I/O cell. This I/O cell contains a Zener diode that serves as a static-shielding diode. It also contains an n-type driver and a p-type driver for driving a signal line coupled to a pad. The n-type driver and p-type driver are both much larger in size than other transistors in the I/O cell. The I/O cell also contains an input buffer and a pre-driver. The input buffer includes a pull-up resistive element (pull-up transistor), a pull-down resistive element (pull-down transistor), a static-shielding resistive element, and the like. The pre-driver includes transistors for driving the n-type and p-type drivers, and the like. The I/O cell also contains control logic that includes various types of logic circuits for controlling the pre-driver and input buffer.

As shown in FIG. 20, the Zener diode, a transistor for the n-type driver, a transistor for the p-type driver, a transistor for the p-type input buffer, a transistor for the n-type input buffer, a transistor for the p-type pre-driver, and a transistor for the n-type pre-driver contained in the I/O cell are formed in the high voltage region (HVDD region). On the other hand, a transistor for the n-type control logic and a transistor for the p-type control logic are formed in the low voltage region (LVDD region). Forming the high and low voltage regions sequentially in this way allows the boundaries between the structures (gate oxide film pressure, etc.) for forming the high and low voltage regions to be reduced as much as possible, as well as allows the boundaries between the structures (well boundaries, etc.) for forming the n-type and p-type regions to be reduced as much as possible. This makes it possible to embody this invention with a simpler structure, as well as with ease.

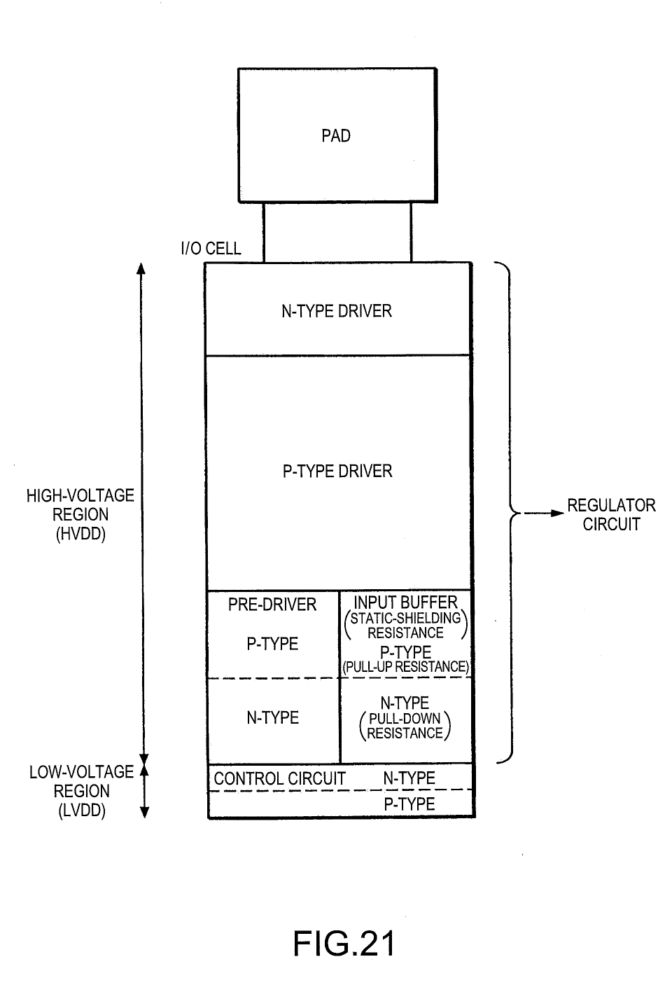

In this embodiment, the regulator circuit is formed using the elements in the high voltage region of the I/O cell, as shown in FIG. 20. For example, the output transistor TQ2 in FIG. 5 is formed using the p-type driver (high voltage transistor) in FIG. 20. The resistive element RP in FIG. 5 is formed using the static-shielding resistive element in FIG. 20. Other transistors TQ1 and TA1 to TQ9, and the like are formed using the transistors (high voltage transistors) disposed in the input buffer, pre-driver, and the like in FIG. 20. As shown in FIG. 21, a modification that includes no Zener diode can also be made. Further, if there is no distinction between the regions or transistors in the integrated circuit device in terms of high and low voltages, or if a low voltage region, or a power supply voltage that causes no damage to the transistors is supplied from the outside even though there is a distinction between the regions or transistors in the integrated circuit device in terms of high and low voltages, the regulator circuit according to this invention need not be disposed in the high voltage region.

According to this embodiment, since the regulator circuit is formed using elements, such as a transistor, a resistance, and the like, disposed in the I/O cell, the regulator circuit 11 can be disposed in an arbitrary position of the I/O cell, as shown in FIG. 19. This allows flexibility in pin arrangement or the like to be improved, as well as allows ESD resistance to be enhanced, thereby improving reliability.

While this embodiment has been described in detail above, it will be understood by those skilled in the art that a number of modifications can be made to this embodiment without substantially departing from new matters and advantages of this invention. Therefore, it is to be noted that these modifications are all included in the scope of this invention. For example, terms (VSS, HVDD, n-type, p-type, reference voltage, etc.) that have been described at least once along with a broader or synonymous term (first power supply, second power supply, first conductivity type, second conductivity type, generated voltage, etc.) in the specification or accompanying drawings can be replaced with those broader or synonymous terms in any part of the specification or the drawings. Also, the configurations and operations of the regulator circuit and integrated circuit device are not limited to what have been described in this embodiment and various modifications can be made thereto. For example, a modification in which the coupling relations among the transistors included in the regulator circuit are changed or a modification in which other transistors, resistive elements, or the like are added can be made. Also, the layout of the integrated circuit is not limited to what have been described in this embodiment. Further, combinations of the modifications that have been described in this embodiment can be included in the scope of the invention.

What is claimed is:

1. A regulator circuit for generating a regulation voltage obtained by stepping down a power supply voltage, comprising:
a plurality of voltage generation circuits, each voltage generation circuit generating a reference voltage;
a differential amplifier circuit, a reference voltage generated by one of the voltage generation circuits being inputted to a first input terminal of the differential amplifier circuit, the regulation voltage generated by the regulator circuit being inputted to a second input terminal of the differential amplifier circuit, the differential amplifier circuit amplifying a difference between the reference voltage and the regulation voltage; and
an output circuit, coupled to an output terminal of the differential amplifier circuit, outputting the regulation voltage and including:
a first output transistor of a first conductivity type, the first output transistor being provided between an output terminal of the regulator circuit and a first power supply, the output terminal of the differential amplifier circuit being coupled to a gate of the first output transistor; and
a second output transistor of a second conductivity type, the second output transistor being provided between a second power supply and the output terminal of the regulator circuit, the output terminal of the differential amplifier circuit being coupled to a gate of the second output transistor.

2. The regulator circuit according to claim 1, wherein the differential amplifier circuit includes:
a differential section having the first and second input terminals;
a first output section, a first output terminal of the differential section being coupled to the first output section; and
a second output section, a second output terminal of the differential section being coupled to the second output section.

3. The regulator circuit according to claim 2, wherein:
the differential section includes:
a first transistor of the second conductivity type for generating a bias current, the first transistor being provided between the second power supply and a first node;
a second transistor of the second conductivity type provided between the first node and a second node, a gate of the second transistor being the first input terminal;
a third transistor of the second conductivity type provided between the first node and a third node, a gate of the third transistor being the second input terminal;
a fourth transistor of the first conductivity type provided between the second node and the first power supply, a gate and a drain of the fourth transistor being coupled to the second node;
a fifth transistor of the first conductivity type provided between the third node and the first power supply, a gate and a drain of the fifth transistor being coupled to the third node;
a sixth transistor of the second conductivity type provided between the second power supply and a fourth node, a gate of the sixth transistor being coupled to the fourth node;
a seventh transistor of the first conductivity type provided between the fourth node and the first power supply, a gate of the seventh transistor being coupled to the second node;
an eighth transistor of the second conductivity type provided between the second power supply and a fifth node, a gate of the eighth transistor being coupled to the fourth node; and
a ninth transistor of the first conductivity type provided between the fifth node and the first power supply, a gate of the ninth transistor being coupled to the third node.

4. The regulator circuit according to claim 1, wherein the differential section includes:
a tenth transistor of the first conductivity type provided between the second node and the first power supply, the tenth transistor being turned on or off depending on a control signal; and
an eleventh transistor of the first conductivity type provided between the third node and the first power supply, the eleventh transistor being turned on or off depending on a control signal.

5. The regulator circuit according to claim 1, wherein the output circuit includes a first output-state controlling transistor of the first conductivity type provided between the first output transistor and the first power supply, the first output-state controlling transistor being turned on or off depending on a control signal.

6. The regulator circuit according to claim 1, wherein the output circuit includes a second output-state controlling transistor of the second conductivity type provided between the second power supply and an output terminal of the differential amplifier circuit, the second output-state controlling transistor being turned on or off depending on a control signal.

7. The regulator circuit according to claim 1, further comprising a static-shielding resistive element provided between the second input terminal and an output terminal of the regulator circuit.

8. The regulator circuit according to claim 1, wherein:
the voltage generation circuits are controlled by a plurality of control signals;
any one of the voltage generation circuits generates a reference voltage depending on the plurality of control signals; and
an output terminal of the other voltage generation circuit is put into a high impedance state.

9. The regulator circuit according to claim 1, further comprising a plurality of coupling elements disposed between output terminals of the voltage generation circuits and the first input terminal of the differential amplifier circuit, any one of the coupling elements being turned on, the other coupling elements being turned off.

10. The regulator circuit according to claim 1, further comprising a plurality of switches disposed between output terminals of the voltage generation circuits and the first input terminal of the differential amplifier circuit, any one of the switches being controlled so as to be turned on depending on the control signals, the other switches being controlled so as to be turned off depending on the control signals.

11. The regulator circuit according to claim 1, further comprising a plurality of pieces of wiring disposed between output terminals of the voltage generation circuits and the first input terminal of the differential amplifier circuit, conductivity of any one of the pieces of wiring being enabled, conductivity of the other pieces of wiring being disabled.

12. An integrated circuit device, comprising:
the regulator circuit according to claim 1; and
an internal circuit, the internal circuit receiving the regulation voltage from the regulator circuit as a power supply and operating on the regulation voltage.

13. The integrated circuit device according to claim 12, further comprising a first pad, an output terminal of the regulator circuit being coupled to the first pad.

14. The integrated circuit device according to claim 13, wherein a capacitor for stabilizing the regulation voltage generated by the regulator circuit is coupled to the first pad.
